(19) United States
(12) Patent Application Publication
(10) Pub. No.: US 2017/0235898 A1
(43) Pub. Date: Aug. 17, 2017

(54) System and Method of Patient Flow and Treatment Management

(71) Applicant: Disruptive IP, Inc., Apollo, PA (US)

(72) Inventors: Robert Craig Coulter, Apollo, PA (US); Ralph Gross, Pittsburgh, PA (US); Jean-Francois Lalonde, Pittsburgh, PA (US); Barbara Anne-Marie Simard, Pittsburgh, PA (US)

(21) Appl. No.: 15/430,622

(22) Filed: Feb. 13, 2017

Related U.S. Application Data
(63) Continuation of application No. 12/872,434, filed on Aug. 31, 2010, now abandoned.
(60) Provisional application No. 61/238,365, filed on Aug. 31, 2009.
(60) Provisional application No. 61/238,420, filed on Aug. 31, 2009.

(51) Int. Cl. G06F 19/00; G06Q 10/06

(52) U.S. Cl. CPC G06F 19/327; G06Q 10/063114

(57) ABSTRACT

In a system and method of patient flow and treatment management, information regarding a patient admitted to a first unit of a patient treatment facility that is received into a first one of a number of user devices is dispatched to a server computer. Upon receipt of this patient information the server computer runs (desirably in real-time) a prediction application/algorithm that predicts an estimate of (1) the patient needing a resource in the first unit or a second unit of the facility, (2) a length of time before the patient needs the resource, and/or (3) an identity of the unit that has the needed resource. The server computer then dispatches (again, desirably in real-time) one or more of the predictions to one or more of the user devices, each of which receives and displays the prediction on a display thereof.

### CROSS REFERENCE TO RELATED APPLICATIONS

This application is a continuation of U.S. patent application Ser. No. 12/872,434, filed August 31, 2010, which claims priority from U.S. Provisional Patient Application Nos. 61/238,365, filed Aug. 31, 2009, entitled “System and Method of Predicting, Planning and Managing Patient Flow in a Hospital”, and 61/238,420, filed Aug. 31, 2009, entitled “System and Method of Directing Patients to Treatment Appropriate Care Facilities”, all of which are incorporated herein by reference.

### BACKGROUND OF THE INVENTION

Field of the Invention

The present invention relates to real-time admission prediction and task execution in a clinical environment, such as, without limitation, a hospital emergency department. The present invention also relates to real-time direction of patients of appropriate care facilities.

Description of Related Art

With the dramatic expansion of knowledge in medicine over the last century came an equally extensive increase in complexity in patient treatments for an ever expanding list of illnesses. Patients coming to a hospital today therefore rarely just see one medical professional but interact either directly or indirectly with dozens of clinicians, IT systems, medical devices, etc. As an example, one study reported that the average ICU patient at the time required 178 individual actions per day (e.g. drug administration, checking vitals, suctioning lungs). Each such action is associated with the usage of one or multiple hospital resources, ranging from the nurse that provides direct patient care and the doctor diagnosing the patient and creating a treatment plan, to imaging devices such as CT or MRI scanners or X-Ray machines, lab slots for the analysis of a blood sample, and the pharmacist preparing a drug. The usage of these resources within a hospital is currently poorly coordinated with manually created schedules, an inefficient mix of paper charts and electronic medical records (EMR), along with numerous phone calls, pages and voice mails. The resulting system is very inefficient, requiring the nursing staff to spend a disproportionally large amount of their time on care coordination. A 2008 time and motion study following 767 nurses found that 20.6% of their time was spent on care coordination with only 19.3% of time being account for by direct patient care. Despite these efforts patients routinely wait long hours for care, no matter if previously scheduled or not.

Nowhere else in the hospital are the problems associated with inefficient resource use and scheduling more apparent than in the emergency department (ED). EDs in the United States are under increasing pressure. The number of visits to emergency departments increased from 90.3 million in 1993 to 113.9 million in 2003 (a 26% change) while the number of U.S. EDs decreased by 12.3% over the same period. As a consequence hospitals have to, at times, go on ambulance diversion where ambulances are redirected to other (potentially more distant) facilities since the ED can not accept any more patients. Along with the increase in demand (and decrease in supply), patient wait times increased. According to a 2008 U.S. Government Accountability Office study, even patients who come to the hospital with ‘immediate’ needs wait an average of 28 minutes to see a doctor. Patients across all hospitals spend on average more than 3 hours in the ED.

Since the front doors of the ED unit never close, the clinical staff is constantly under pressure to treat patients quickly and move them out again through either discharge, transfer to another facility or unit within the hospital, or admission to the hospital. In order to transfer an admitted patient out of the ED unit though, a bed in the appropriate hospital unit has to be available. This is often not the case. Bed requests are typically only issued at the end of the often hours-long workup in the ED after a formal admit decision has been made. In addition, appropriate nursing resources are required as well. If the in-hospital unit has sent home nurses for the day already, the unit may not be able to take on any more patients from the ED even if beds would be available. Freeing up a bed can, by itself, be a time consuming process. It might involve discharging a patient from a step-down unit and moving another patient from the intensive care unit (ICU) to the just emptied bed, to then be able to move an ED patient into the ICU bed. During the execution of this process, the patient is ‘boarded’ in the emergency department, continuing to tie up costly resources.

Typically little or no information about patients in the ED unit reach the other/interior units of the hospital during the ED workup. As a consequence, the preparation of resources for patients that are admitted to the hospital is not started until a formal admission decision has been made, often hours after the patient arrived at the ED unit. The problem arising from this is the extended time that admitted patients have to wait in the ED (while continuing to consume ED resources) until they can be transferred to the appropriate interior unit.

The uncertainty about a patient's near-term status extends beyond the front doors of the emergency department. The ED generally only learns about its patients and their needs when either (i) they present to the ED Triage Nurse in person at the front door, or (ii) the ambulance arrives at the ED. Even if patients or ambulances do call ahead, EDs often lack the ability to use “call in” information of any kind to prepare resources for their incoming patients. The standard ED process is “triage at the door”, although chest pain diagnosis is one arena in which “remote triage” for in-transit emergency patients has begun to develop, with promising results.

Patients seeking medical care are in a similar situation. They often only have limited information about the general capabilities and the current status of a given ED. As a consequence, patients whose condition can be treated at an urgent care center may end up going to an overcrowded emergency department, enduring a long wait time while further contributing to the patient overload there. According to the Centers for Disease Control and Prevention (CDC), 1600 Clifton Rd. Atlanta, Ga. 30333, USA, 45.5% of patients visiting the emergency department in 2007 had a procedure done. However, the majority of those were common procedures such as administration of IV fluids, repair of a laceration or a nebulizer treatment, which could have been done in an urgent care center.

The lack of information about emergency departments extends to emergency medical technicians (EMTs) in ambulances as well. They generally do not have up-to-date information about current ED patient levels and sometimes even lack accurate information about the capabilities of emergency departments as shown in studies in which between 7% and 21% of trauma patients were taken to the wrong hospital.

Furthermore, patients coming to an emergency department (either on their own or in an ambulance) and the emergency department to which a patient is heading to typically know very little about each other. As a consequence patients (and ambulances) regularly make suboptimal decisions about which facility to go to and EDs are unable to prepare resources for incoming patients.

### SUMMARY OF THE INVENTION

In one embodiment, the present invention improves in this inefficient admission process by predicting, for each patient in the emergency department (ED), the likelihood of admission, the time until admission would occur, as well as the admitting hospital unit. Usage of this admission likelihood enables staff in interior hospital units (e.g., staff in units other than the ED unit) to prepare an appropriate bed resource in parallel with the ED workup, significantly reducing the time it takes to get a patient from the ED into a hospital unit.

More specifically, the invention is a method of patient flow and treatment management via one or more computerized user devices in operative communication with a programmed computer. The method includes: (a) receiving in the computer patient information regarding a patient admitted to a first unit of a patient treatment facility, said patient information comprising one or more of the following: patient triage data, patient vital signs, one or more tasks related to treatment of the patient, and a completion state of each said task; (b) a prediction module hosted by the computer predicting an estimate of at least one of the following based on said patient information received in step (a): (1) the patient requiring a resource in either the first unit or a second unit of the facility, (2) a length of time before the resource in step (b)(1) is required, and (3) an identity of the first or second unit; and (c) the computer dispatching to one or more of the user devices a request for the resource, said request determined by a decision module hosted by the computer based on the prediction in step (b).

The method can further include repeating steps (a)-(c) for another patient admitted to the first unit. The method can also include maintaining a record of the state of each task as being either complete or not complete.

The one or more user devices of step (c) can include a second user device assigned to a person in the second unit. At least part of the patient information received by the computer in step (a) is initially input into one or more of the user devices.

In response to receiving an indication that a task is complete, the computer can assign a predetermined charge to said task and, following discharge of the patient from the first unit, the computer aggregating all of the completed tasks and charges onto an invoice related to said patient.

The resource can include a capital resource or a human resource. The human resource can include a specialist. The capital resource can include a bed, a medical diagnostic imaging scan, or a lab test.

The patient triage data can include one or more of the following: age of the patient; gender of the patient; mode of the patient's arrival at the facility; time of the patient's arrival at the facility; recent patient treatment facility visits by the patient, the patient's symptom(s) regarding the patient being admitted to the first unit, the patient's decision to seek medical treatment, and a duration of the symptom(s).

The patient vital signs can include one or more of the following: a temperature of the patient, the patient's pulse rate, the patient's blood pressure, and the patient's respiratory rate.

The one or more tasks related to the patient can include one or more of the following: patient blood or urine tests, EKG, patient imaging tests (e.g., x-ray, CT, MRI, Ultra-sound), medications or treatment (saline) to be administered to the patient (e.g., intravenously, orally, or by injection); breathing tests or treatments, and the like. However, the ordering of any suitable and/or desirable task related to the diagnosis and/or treatment of the patient is envisioned. The completion state of each task can either be “complete” or “not complete”.

The invention is also a method of patient flow and treatment management via one or more computerized user devices in operative communication with a programmed computer that includes: (a) receiving into a first user device patient information regarding a patient admitted to a first unit of a patient treatment facility, said patient information comprising one or more of the following: patient triage data, patient vital signs, one or more tasks related to treatment of the patient, and a completion state of each said task; (b) dispatching the patient information received in step (a) from the first user device to the computer; (c) receiving at a second user device from the computer a request for a resource in either the first unit or a second unit of the facility determined based on a prediction of at least one of the following determined based on the patient information dispatched to the computer in step (b): (1) the patient requiring the resource, (2) a length of time before the resource in step (c)(1) is needed, and (3) an identity of the first or second unit; and (d) the second user device dispatching a response to the resource request of step (c) to the computer.

The method can include repeating steps (a)-(d) for another patient admitted to the first unit. The first and second user devices can be assigned to personnel in the first and second units, respectively.

The method can also include maintaining a record of the state of each task as being either complete or not complete.

The resource can include a capital resource or a human resource. The human resource can include a specialist. The capital resource can include a bed, a medical diagnostic imaging scan, or a lab test.

The invention is also a patient flow and treatment management via one or more computerized user devices in operative communication with a programmed computer that includes: (a) receiving into a first user device patient information regarding a patient admitted to a first unit of a patient treatment facility, said patient information comprising one or more of the following: patient triage data, patient vital signs, one or more tasks related to treatment of the patient, and a completion state of each said task; (b) dispatching the patient information received in step (a) from the first user device to the computer; (c) receiving at the computer the patient information dispatched in step (b); (d) the computer running a prediction application that predicts an estimate of at least one of the following based on the patient information received in step (c): (1) the patient requiring a resource in either the first unit or a second unit of the facility, (2) a length of time before the resource of step (d)(1) is needed, and (3) an identity of the first unit or second; (e) the computer running a decision module that determines based on the estimates predicted in step (d) that a request for the resource should be issued; (f) the computer dispatching the resource request to one or more of the user devices; and (g) each user device dispatched the resource request in step (f) displaying said resource request on a display of said user device.

The first user device can be assigned to a person in the first unit. The one or more user devices of step (f) can include a second user device assigned to a person in the second unit. The second user device can dispatch a response to the resource request to the computer. The resource can include a capital resource or a human resource. The human resource can include a specialist. The capital resource can include a bed, a medical diagnostic imaging scan, or a lab test.

The first and second user devices can be assigned to personnel in the first and second units, respectively.

The invention is also a patient flow and treatment management system comprising: a server computer hosting one or more software modules; a plurality of computerized user devices, each user device including a visual display; and a wireless network connecting the server computer and the user devices, said wireless network operative for: wirelessly delivering from a first user device to the server computer patient information entered into the first user device regarding a patient admitted to a first unit of a patient treatment facility, said patient information comprising one or more of the following: patient triage data, patient vital signs, one or more tasks related to treatment of the patient, and a completion state of each said task; and wirelessly delivering from the server computer to one or more of the user devices for display on the display(s) thereof an estimate of at least one of the following determined by the one or more software modules based on the patient information wirelessly delivered to the server computer: (1) the patient requiring a resource in the first unit or a second unit of the facility, (2) a length of time before the resource is needed, and (3) an identity of the first or second unit.

The one or more user devices wirelessly delivered the estimate includes one or both of the following: the first user device, wherein said first user device is assigned to a person in the first unit; and a second user device assigned to a person in the second unit. In response to receiving the patient information, the server computer causes the one or more software modules to determine the estimate and deliver the estimate to the one or more user devices substantially in real-time. The resource can include a capital resource or a human resource. The human resource can include a specialist. The capital resource can includes a bed, a medical diagnostic imaging scan, or a lab test.

The resource can include a capital resource or a human resource. The human resource can include a specialist. The capital resource can include a bed, a medical diagnostic imaging scan, or a lab test.

Another embodiment of the invention provides suggestions for patients seeking treatment on which facility to go to, notifies the appropriate facility about the incoming patient, and factors the additional resource needs of known and predicted incoming patients into the rest of the resource prediction and management system.

Accordingly, the invention is also a method of patient guidance via one or more computerized user devices in operative communication with a programmed computer. The method includes: (a) receiving in the computer from a user device patient information regarding a patient seeking medical treatment, said patient information including or more of the following: patient medical history, information, patient health insurance information, patient triage data, patient vital signs, and current location data; (b) a patient guidance module hosted by the computer matches the patient information to two or more patient treatment facilities based on a mapping of the patient information to patient treatment facilities; (c) the patient guidance module generates a sorted list of patient treatment facilities based on one or more of the following: a distance of each facility to the patient determined from the current location data, a travel time to each facility, cost of patient care at each facility, and available resources at each facility; and (d) the computer dispatches the sorted list of step (c) to the user device.

Based on the triage data indicating whether immediate care is required or not, the patient guidance module can generate the sorted list based on patient census in one or more of said facilities.

The invention is also a method of patient guidance via one or more computerized user devices in operative communication with a programmed computer that includes: (a) receiving into a user device patient information regarding a patient seeking medical treatment, said patient information including or more of the following: patient medical history, information, patient health insurance information, patient triage data, patient vital signs, and current location data; (b) dispatching the patient information received in step (a) from the user device to the computer; (c) receiving at the user device from the computer a sorted list of patient treatment facilities determined based on one or more of the following: a distance of each facility to the patient determined from the current location data, a travel time to each facility, cost of patient care at each facility, and available resources at each facility; and (d) the user device dispatching a selection of one of the facilities to the computer.

An order of the facilities in the sorted list can be based on whether the triage data indicates that immediate care is required or not.

The invention is also a method of patient guidance via one or more computerized user devices in operative communication with a programmed computer that includes: (a) receiving into a user device patient information regarding a patient seeking medical treatment, said patient information including or more of the following: patient medical history, information, patient health insurance information, patient triage data, patient vital signs, and current location data; (b) dispatching the patient information received in step (a) from the user device to the computer; (c) receiving the patient information dispatched in step (b) at the computer; (d) a patient guidance module hosted by the computer matching the patient information received in step (c) to two or more patient treatment facilities based on a mapping of patient treatment facilities to patient information and generating a sorted list of patient treatment facilities based on one or ore of the following: a distance of each facility to the patient determined from the current location data, a travel time to each facility, cost of patient care at each facility, and available resources at each facility; (e) the computer dispatching the sorted list of step (d) to the user device; (f) the user device receiving the sorted list dispatched from the computer in step (e); and (g) the user device dispatching a selection of one of the facilities to the computer.

An order of the facilities in the sorted list can be based on whether the triage data indicates that immediate care is required or not.

Lastly, the invention is a patient guidance system that includes: a server computer hosting one or more software modules; a user device including a visual display; and a wireless network connecting the server computer and the user device, said wireless network operative for: wirelessly delivering from the user device to the server computer patient information including or more of the following: patient medical history, information, patient health insurance information, patient triage data, patient vital signs, and current location data; and wirelessly delivering from the server computer to the user device for display on the display thereof a sorted list of patient treatment facilities determined from a mapping of patient treatment facilities to patient information based on one or more of the following: a distance of each facility to the patient determined from the current location data, a travel time to each facility, cost of patient care at each facility, and available resources at each facility.

### BRIEF DESCRIPTION OF THE DRAWINGS

FIG. 1 is a block diagram of a system in accordance with the present invention;

FIG. 2 is a block diagram of the elements comprising each handheld device of FIG. 1;

FIG. 3 is a block diagram of the software modules comprising the CLM server computer of FIG. 1;

FIG. 4 is a non-limiting example of a display that appears on the visual display of a handheld device utilized by a caregiver in the emergency department (ED) unit of a patient treatment facility (e.g., a hospital or urgent care center);

FIG. 5 is an exemplary, non-limiting, interaction between the CLM server computer of FIG. 1 and an ED caregiver application running on a handheld device of a caregiver in the ED unit of a patient treatment facility;

FIG. 6 is a non-limiting example of a display that appears on the visual display of a handheld device of each facility person charged with assigning patients to resources (e.g., available beds) under the control of bed board interface module of the CLM server computer of FIG. 1; and

FIG. 7 is a flow chart of the steps of a bed plan module implemented by the CLM server computer of FIG. 1.

### DESCRIPTION OF THE PREFERRED EMBODIMENT(S)

The present invention will now be described with reference to the accompany figures where like reference numbers correspond to like elements.

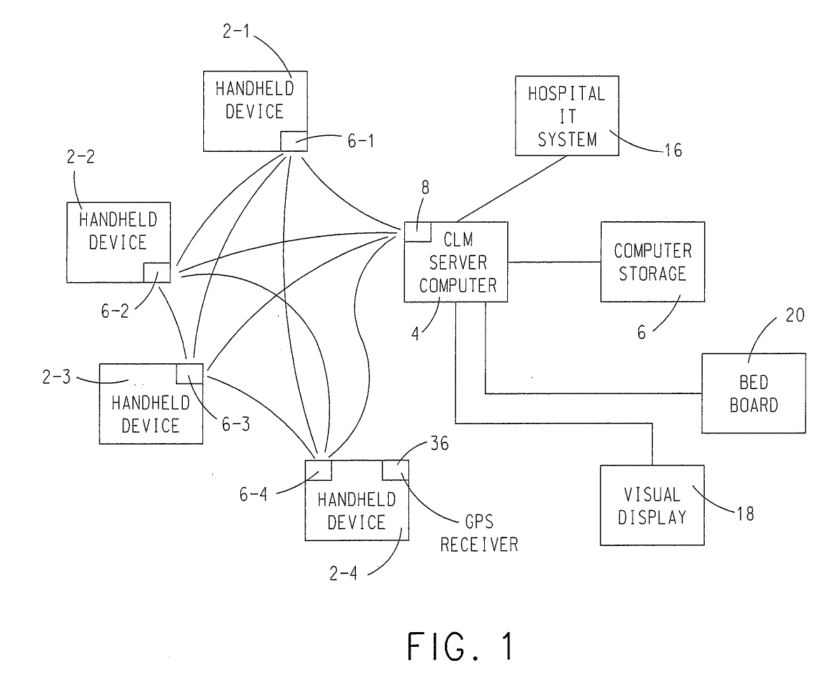

With reference to FIG. 1, an exemplary, non-limiting, system in accordance with the present invention includes a plurality of handheld or mobile devices 2 in communication with a Care Logistics Management (CLM) server computer 4 that has access to a computer storage 6. Each handheld device 2 includes a wireless transceiver 6, and CLM server 4 includes or is coupled in operative relation to a wireless transceiver 8. Each transceiver 6 is operative for establishing two-way communication with each other transceiver 6 and with transceiver 8. Similarly, transceiver 8 is operative for establishing two-way communication with each transceiver 6. The physical location of CLM server 4 and transceiver 8 is not to be construed as limiting the invention since it is envisioned that CLM server 4 and transceiver 8 can be located at or remotely from a patient treatment facility (e.g., hospital).

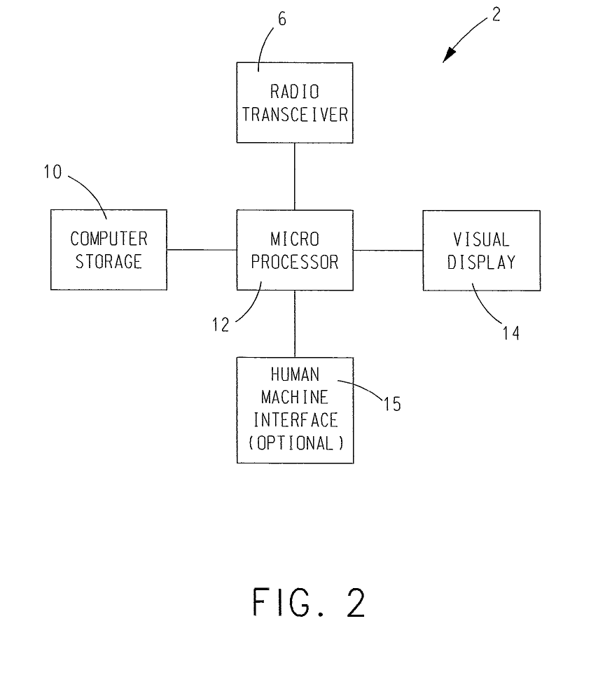

With reference to FIG. 2 and with continuing reference to FIG. 1, each handheld device 2 includes (in addition to a transceiver 6) a computer storage 10, a microprocessor 12 and a visual display 14. Microprocessor 12 is programmed in a manner known in the art to control the operations of transceiver 6, computer storage 10, and visual display 14. Desirably, visual display 14 is a touch screen display operating under the control of the programming of microprocessor 12 to display one or more virtual buttons, each of which can be activated by a user of the handheld device 2 in a manner known in the art to cause microprocessor 12 to perform a function associated with said virtual button. Also or alternatively, each handheld device 2 can include an optional human machine interface (HMI) 15 comprised of one or more buttons (e.g., a keyboard), a track ball, and the like known in the art to facilitate user input of data into handheld device 2. Each handheld device 2 can also include telephone functions such as those found in a standard cell phone.

CLM server 4 can also be coupled to a visual display 18 that may be a touch screen display operating under the control of CLM server 4. Also or alternatively, CLM server 4 may include or be coupled to a suitable HMI (not shown) to facilitate data entry into CLM server 4. A bed board 20 (described hereinafter) may also be coupled to CLM server 4. CLM server 4 comprises various elements, such as a processor, computer memory, and the like, which are well known in the art and which are not shown in the figures for the purpose of simplicity.

Handheld devices 2 and CLM server 4 can be operative for implementing a distributed communication network architecture. In one non-limiting embodiment, this distributed communications network architecture is a peer-to-peer architecture. In another non-limiting embodiment, the communication network architecture can be a centralized server based architecture.

In the peer-to-peer architecture, each handheld device 2 can be placed by CLM server 4 into direct one- or two-way communication with one or more other handheld devices 2. In the centralized server-based architecture, all communications from between handheld devices 2 is routed through CLM server 4. Since such architectures are well known in the art, details regarding such architectures will not be described herein for purpose of simplicity. Desirably, the present invention is implemented as a peer-to-peer architecture.

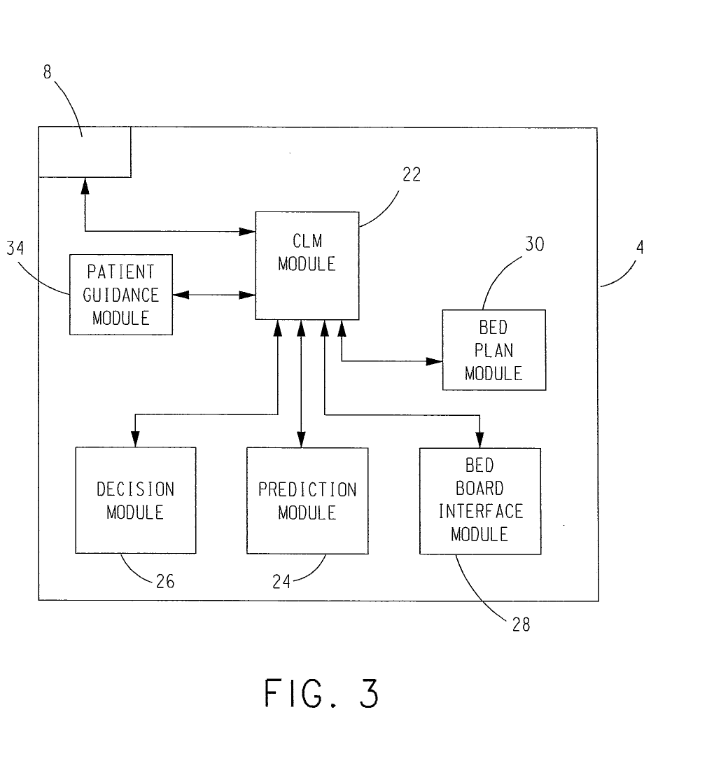

With reference to FIG. 3 and with continuing reference to FIGS. 1 and 2, CLM server 4 may include a number of software modules described hereinafter. In the embodiment shown in FIG. 3, CLM server 4 includes a Care Logistics Management (CLM) module 22 that manages the operation of CLM server 4 including communication between a hospital IT system 16, handheld devices 2, and other software modules/engines of CLM server 4. Hospital IT system 16 can host an electronic medical record (EMR) application that includes for each patient a record of, without limitation, the patient's triage data, vital signs (vitals), physician order(s) for the patient, task completion/execution data, estimates of the patient's status, the unit where the patient is presently being treated in the facility, and the like. This patient record or patient information can be included in EMR application running on hospital IT system 16 in any suitable and/or desirable manner, including via one or more handheld devices 2, whereupon said patient information input into said one or more handheld devices 2 is forwarded by CLM server 4 to hospital IT system 16 for storage and subsequent retrieval. Hospital IT system 16 may also receive patient information from any other suitable and/or desirable input.

CLM server 4 also includes a prediction module 24 that takes as input from CLM module 22 patient information regarding any one or combination of the following for each patient in a facility emergency department (ED) unit: triage data, patient vital signs (vitals), physician order(s)/task(s), and task completion/execution data. CLM module 22 can receive this information (and other information) from hospital IT system 16, from one or more handheld devices 2 (each of which is under the control of one caregiver (e.g., treating physician, nurse, imaging technician, etc.) in the ED unit), or some combination of hospital IT system 16 and one or more handheld devices 2. Based on the information received from CLM module 22, prediction module 24 predicts for each patient in the ED the likelihood of admission, time until the conclusion of the ED workup, and, assuming the patient is likely to be admitted, the hospital unit where the patient will be admitted (assigned) from the ED. The information computed by prediction module 24 is returned to CLM module 22 for further disposition.

CLM server 4 also includes a decision module 26 that takes the output(s) from prediction module 24 returned to CLM module 22 and applies a (e.g., hospital or urgent care center) specific decision function to determine if/when preparation of a resource (e.g., a bed) in an interior unit of the facility for a patient presently in the ED unit should be started. Herein, “interior unit” means a unit in the facility other than the ED unit. Non-limiting examples of interior units include the intensive care (ICU) unit, a surgical unit, an operating room unit, a trauma unit, or any other unit which provides special patient care.

Via its respective transceiver 6, each handheld device 2 assigned to personnel in the ED can display one or more patients in the ED unit along with a list of physician order(s) for each said patient. Physician orders may include, without limitation, one or more tasks to be performed on a patient related to the treatment of the patient in the ED. Non-limiting examples of such tasks include blood tests, imaging tests, medications, etc., that have been entered into CLM module 22 via hospital IT system 16, one or more handheld devices 2, or some combination of hospital IT system 16 and one or more handheld devices 2.

As each physician order/task is completed, a suitable caregiver for the patient in the ED unit upon becoming aware of the completion of the physician order/task enters an indication of such completion in the caregiver's handheld device 2. This indication is then communicated by said handheld device 2 (via the transceiver 6 thereof) to CLM module 22 in real-time for processing by prediction module 24 which can be programmed to determine from said indication an estimate of when the ED workup for the patient will be complete. In addition, one or more of the patient's caregivers in the ED may also provide to CLM module 22 for processing by prediction module 24 their prediction whether the patient is going to be admitted.

CLM server 4 may optionally include a bed board interface module 28 for causing a graphical display to displayed (e.g., on the visual display 14 of each of one or more handheld devices 2 of caregivers in the ED unit or personnel in an interior unit) some or all of the following information: the time remaining until the end of a patient's ED workup, the likelihood of admission of the patient to the interior unit, and the likely interior unit where the patient will be admitted. For example, the graphical display could be a bar chart where the time remaining until the end of the ED workup is represented on the x-axis, the likelihood of admission is represented by on the y-axis, and the likely admitting unit is represented by the color of the box representing the patient.

CLM server 4 can optionally include a bed plan module 30, e.g., when a facility does not use a bed board. Bed plan module 30 desirably acquires bed occupancy information from a suitable source, e.g., hospital IT system 16. Upon receiving information from decision module 26 that a patient in the ED unit is to be admitted to a particular interior unit, CLM module 22 forwards this information to bed plan module 30 which matches the patient to an empty bed in the interior unit and which causes CLM module 22 to communicate this suggested match to each of one or more handheld devices 2 of one or more personnel in the interior unit, e.g., the handheld device 2 of the supervisory nurse of the interior unit. If the match is accepted by personnel in the interior unit, e.g., via a suitable entry in a handheld device 2 assigned to personnel in the interior unit, this match is communicated by said handheld device 2 via server computer 8 to hospital IT system 16 for subsequent storage and retrieval. This match can also be communicated via server computer 8 to one or more suitable handheld devices 2 of one or more personnel in the ED unit.

On the other hand, if bed plan module 30 determines from the occupancy information that no bed is available, bed plan module 30 responds to the information that the patient is to be admitted by returning to one or more handheld devices 2 of personnel in the ED a suggestion to discharge the patient. Upon accepting the discharge suggestion, CLM module 22 informs one or more handheld devices 2 of the patient's virtual care team (described hereinafter) of the need to collaborate in the discharge process. If no suitable patient candidate is available for discharge, bed plan module 30 searches for an alternative bed using a predetermined mapping of possible transfers to another unit, i.e., a unit other than the originally suggested interior unit (e.g. from ICU to a surgical unit, or from the operating room (OR) unit to a trauma unit). If a bed is found in such other unit, the handheld devices 2 of personnel, e.g., a supervisory nurses, at the originating and receiving units are notified by CLM module 22 of the availability of the bed and are organized by CLM module 22 into a virtual team to facilitate the patient's transfer to said bed.

Each handheld device 2 can be programmed and operative for the role to be performed by the person assigned the handheld device 2. For example, without limitation, a handheld device 2 of a caregiver in the ED unit can be programmed to display screens for each ED patient under the care of said caregiver related to, without limitation, triage data, vitals, physicians orders/tasks, related to treatment of the patient and the completion state (complete or not complete) of one or more of the displayed tasks for said patient. In contrast, a handheld device 2 of a unit nurse in an interior unit may be programmed to display bed requests, and, if the ED patient is to be assigned to the interior unit, information regarding the patient, e.g., without limitation, patient vitals, transfer requests, discharge requests, etc.

Each module of CLM server 4 will now be described in greater detail.

Care Logistics Management (CLM) Module

CLM module 22 maintains a connection with hospital IT system 16 utilizing a suitable interface, e.g., without limitation, a Health Level-7 (HL7) interface known in the art. CLM module 22 also communicates with handheld devices 2 of ED unit nurses and interior unit charge nurses to update patient data, receive task completion state information, send alerts, and facilitate role-based collaboration and virtual teams.

Role-Based Collaboration:

The efficiency of a facility's caregiver (e.g., nursing) staff is often driven by personal relationships between caregivers in different units of the facility. Personal relationships generate efficiency improvements simply because a caregiver in one unit knows exactly who to call in the another unit in order to get help with an issue at hand, i.e. the caregiver knows the exact person that performs the healthcare role that they need to collaborate with in order to treat a patient. Role-based collaboration is already used by physicians to collaborate in patient care. For example, when an attending physician determines that he or she needs additional expertise, e.g., in cardiology, they request a consult from the on-call cardiologist, who comes to the patient and collaborates in the diagnosis. Caregivers at all levels of patient care would benefit from a similar capability for logistical collaboration.

The present invention integrates direct person-to-person (or group) communications driven by caregiver roles. For example, rather than having to know that Nurse Smith in radiology is the correct nurse to help coordinate the transport of a patient to and from radiology, a nurse in a medical/surgical unit could simply press a real or virtual button on her handheld device 2 that causes the handheld device 2 to be linked to the handheld device belonging to the logistics collaboration nurse in radiology—regardless of the identity of the latter nurse at that time. To this end, CLM server 4 can be programmed to track which nurse presently on-duty fulfills the role of the logistics collaboration nurse in radiology, e.g., via a directory accessible to CLM module 22 of CLM server 4 that includes the identity of the on-duty logistics collaboration nurse in radiology. Thus, in response to a first nurse in the medical/surgical unit pressing on her handheld device 2 the button associated with the collaboration nurse in the radiology unit, CLM server 4 determines which employee presently on-duty is the logistics collaboration nurse in the radiology unit and retrieves from computer storage 6 the network address (or phone number) of said collaboration nurse's handheld device 2 and causes said handheld device 2 to be placed into one- or two-way communication with the handheld device 2 of the first nurse. In this manner, nurses can quickly reach a desired role counterpart in any unit of the hospital in order to collaborate in the solution of logistics problems. Moreover, patient information presently in the requesting nurse's queue can be used to both: (i) direct the connection to the appropriate resource automatically, and (ii) provide precise supporting information to that resource to help speed the resolution of the issue.

This allows for the automation of direct communications based on an electronic directory to match a caregiver role to the handheld device 2 belonging to the person who (today, or during this shift) is assigned to carry out that role. Such directory can be dynamically updated by CLM server 4 as role assignments (or staffing assignments) change throughout time.

Virtual Teams:

Role-based collaboration can be a powerful concept in care logistics management. Using the system described herein, this concept can be expanded from caregiver-to-caregiver single-issue collaboration to the creation of virtual teams of caregivers associated with the continuum of a patient's treatment. A virtual team may be formed (and accessible in a database accessible to CLM server 4) around any clinical, logistical, or other issue that requires representatives of one or more areas to work as a team, while potentially physically distributed throughout the healthcare facility or beyond the facility.

For example, a patient may have a virtual team assigned to him or throughout the entire continuum of care, or only at specific stages. The members of the patient's team can change as the patient's needs change. Different members of the team will be active in managing the logistics of a patient's care at different stages of treatment, but any team member can be pulled into the collaboration on a moment-by-moment basis as their participation is required. Such participation can be scheduled far in advance, using the power of predictive modeling, or it can be called in on a stat- or emergency-basis when, for example, a patient codes and requires emergency treatment.

CLM server 4 can assemble a virtual team as a background process, meaning that the creation of the team will not require the active collaboration of any caregiver, until such time as his or her participation in a particular clinical, logistical or other situation is required. Thus, the virtual patient team provides for a new level of collaboration at no additional time cost to the caregivers involved.

Under the control of CLM server 4, one- or two-way communication can be established between two or more handheld device 2 of members of any virtual team in a manner similar to the establishment of communication between two nurses described above in connection with role-based collaboration.

Prediction Module

Prediction module 24 continuously computes estimates for the likelihood of admission, time until the conclusion of the ED unit workup, and the likely admitting hospital unit for each patient currently being treated in the ED. To this end, prediction module 24 desirably includes an admission prediction application, a time prediction application, and a unit prediction application.

Admission Prediction Application

The admission prediction application receives, at different times during a patient's ED workup, some or all of the following patient information:
Triage data: All information collected during the triage of the patient is a candidate for use by the admission prediction application, with the specific choice being dependent on the particular patient mix of the hospital. Typical triage data includes, without limitation: patient age, patient gender, mode of arrival (e.g., ambulance, walk-in, helicopter), time of arrival, recent hospital stays, and chief complaint.
Vitals: The four standard vital signs utilized by the admission prediction application includes, body temperature, pulse rate, blood pressure, and respiratory rate.
Physician orders/tasks ordered by the treating physician related to treatment of the patient. Non-limiting examples of such tasks include: blood tests, imaging tests, medications, lab tests, consultation with a specialist, etc.

In one embodiment of the admission prediction application, separate prediction algorithms are trained using different sets of features: a) only triage data, b) triage data and vitals, c) triage data, vitals, and physician orders, and d) triage data and physician orders (if vitals are not available). In another embodiment of the admission prediction application, only one algorithm is trained which treats features not currently available (e.g. vitals and physician orders at triage time) as missing features. Depending on which data is available at a given point in time the appropriate prediction algorithm is executed by the prediction engine.

An underlying challenge of making an admission prediction is one of classification. To this end, depending on the particular patient treatment facility (hospital), different admission prediction application scenarios are possible. For example, for smaller community hospitals or urgent care facilities, each patient may be classified into one of three categories: namely, admission, discharge, or transfer (to a larger hospital). For larger hospitals, each patient may be classified into one of two categories: admission or discharge. Standard machine learning algorithms are applicable for use by the admission prediction application, e.g. nonlinear discriminant functions such as Support Vector Machines with probability estimates or Relevance Vector Machines. In use with the admission prediction application, each algorithm is desirably trained in a supervised fashion using historical data, extracted from the EMR application, for which the admission decision is known.

The output of the admission prediction application for each patient, in the form of a prediction or estimate that the patient will require a particular facility resource, is provided by prediction module 24 to CLM module 22 which wirelessly dispatches each patient's admission prediction to the handheld device 2 of appropriate facility personnel, e.g., without limitation, one or more of the patient's caregivers in the ED unit and/or one or more personnel in a possible interior unit of the facility.

Time Prediction Application

In order to estimate how long it will take until a decision is made on admitting a patient to an interior unit, an algorithm used by the time prediction application is trained using some or all of the following data (again dependent on the specific facility): time of day, day of week, physician orders, task completion status (obtained from the ED Caregiver Application discussed below), ED patient census, hospital patient census, and resource schedules (e.g., an X-Ray, CT or MRI scanner) if available.

An underlying challenge of making a time prediction of when the patient can be admitted is one of regression in which a relationship is learned between the features discussed above in connection with the admission prediction application and ED completion time as the dependent variable. Nonlinear regression algorithms are applicable to this problem, e.g. Support Vector Machine Regression.

Since all of the data used by the time prediction application may not be available through a hospital's EMR application, the time prediction application is desirably run in training mode for an initial period of time in which only coarse completion time estimates based on chief patient complaint specific averages are given. During this time, relevant data is collected, synchronized with data from the EMR application, and used to train the time prediction application.

The output of the time prediction application for each patient, in the form of a prediction or estimate of a length of time before the resource output by the admission prediction application will be needed, is provided by prediction module 24 to CLM module 22 which wirelessly dispatches each patient's time prediction to the handheld device 2 of appropriate facility personnel, e.g., without limitation, one or more of the patient's caregivers in the ED and/or one or more personnel in a possible interior unit of the facility.

Unit Prediction Application

The unit prediction application is trained using patient demographics and chief patient complaint information from triage along with physician's orders to predict which unit the patient will be transferred to, if admitted. Unit prediction is a classification problem, where all hospital units are classification categories. Again, standard machine learning algorithms are applicable to this problem, e.g. nonlinear discriminant functions such as Support Vector Machines.

The output of the unit prediction application for each patient, in the form of a prediction or estimate of the identity of the unit of the facility has the resource predicted to be needed by the admission prediction application, is provided by prediction module 24 to CLM module 22 which wirelessly dispatches each patient's unit prediction to the handheld device 2 of appropriate facility personnel, e.g., without limitation, one or more of the patient's caregivers in the ED and/or one or more personnel in a possible admitting unit of the facility.

During operation of predication engine 24, the availability of any new or changed data input into predication engine 24 by CLM module 22 can trigger recalculation of the admission prediction, time prediction, and/or unit prediction with the corresponding output to CLM module 22 updated, desirably in real-time.

A patient guidance application (described below) hosted by CLM server 4 can be utilized by patient's that are en route to a patient treatment facility (e.g., hospital) to automatically enter the patient into the patient queue for the prediction application, with an additional time delay estimated from the patients current position en route to the facility and their mode of transportation.

Decision Module

Prediction module 24 produces likely estimates of admission, duration until the end of the ED workup, and likely interior unit for each patient in the ED unit. One or more of these estimates by themselves are only actionable to a limited degree in communicating a general trend, but they do not tell a nurse in an interior unit of the facility (i.e., a unit other than the ED unit) if and when to start preparing a resource, e.g., a bed. This task falls to decision module 26 which takes one or more outputs of prediction module 24 (i.e., admission likelihood, time remaining in the ED, and/or admitting unit) supplied to decision module 26 via CLM module 22, applies said output(s) to a decision table learned from prior data (e.g., data regarding one or more of:: data regarding prior actual admissions versus prior likelihood estimates of admission, data regarding prior actual time remaining in the ED versus prior time estimates of time remaining in the ED, and/or data regarding prior actual admitting units versus prior estimates of admitting unit), and dispatches one or more resource preparation requests, e.g., bed requests, to CLM module 22 if sufficient evidence exists for an admission.

As with any classification, the output of decision module 26 can include errors. Such errors include false positives (issuing resource (bed) requests for patients that end up being discharged) and false negatives (lack of resource (bed) requests for admitted patients). Desirably, decision module 26 monitors false positive and false negative rates and permits the sensitivity. of decision module 26 to be programmed in favor of erring either on the side of false positives or false negatives.

ED Caregiver Application

The time prediction application described above relies upon accurate data on the completion of treatment tasks. To obtain information in real-time, desirably time-stamped information, the present invention includes an ED caregiver application running on each handheld device 2 (which communicates with CLM server 22) carried by a caregiver in the ED unit. The handheld device 2 of each caregiver can display for all patients currently being cared for by said caregiver basic information (demographics, chief complaint) regarding each patient along with the list of orders/tasks ordered by the treating physician.

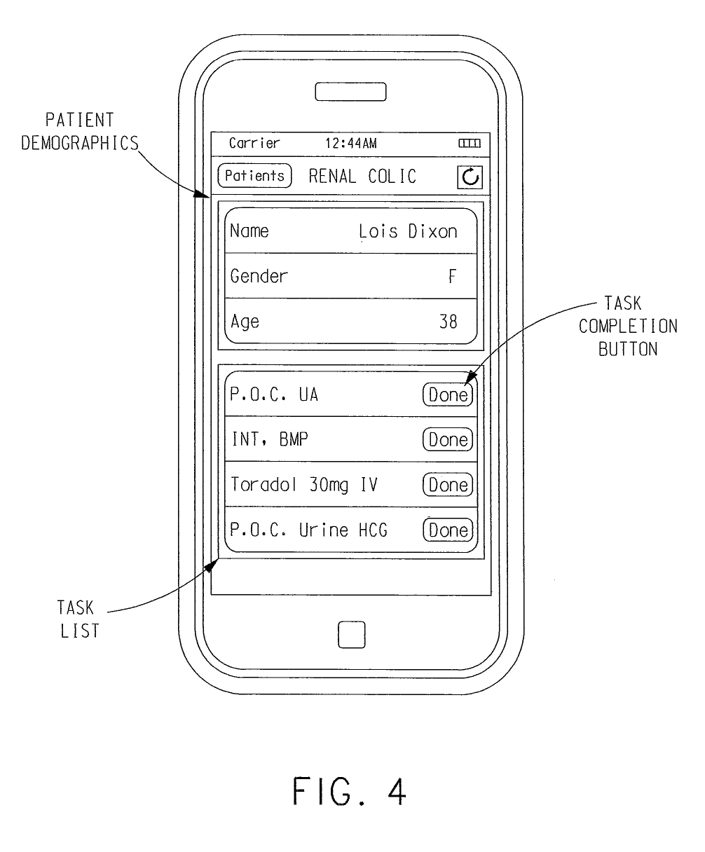

The order/task information on handheld device 2 can be updated, desirably continuously, e.g., from the hospital's EMR application, via CLM module 22. Upon completion of a task on the list (e.g. collect blood specimen, administer a drug, etc.), the caregiver (e.g., nurse) activates a real or virtual button on her handheld device 2 to communicate this information to CLM module 22. The state of completion of each task (complete or not complete) can be maintained at each handheld device having a need to know the completion status of said task, as well as CLM module 22, and hospital IT system 16, as necessary. A non-limiting example of a display that appears on the visual display 14 of a handheld device 2 utilized by a caregiver in the ED is shown in FIG. 4. It is to be understood, however, that the display shown in FIG. 4 is exemplary only and is not to be construed as limiting the invention.

The ED caregiver application can also prompt the caregiver, desirably at regular intervals, to provide an updated estimate on how likely (on a scale from 1 to 10) it is that a patient will be admitted. The caregivers response to this prompt is communicated, desirably in real-time to, CLM module 22 for processing by the admission prediction application to determine an updated admission likelihood for the patient.

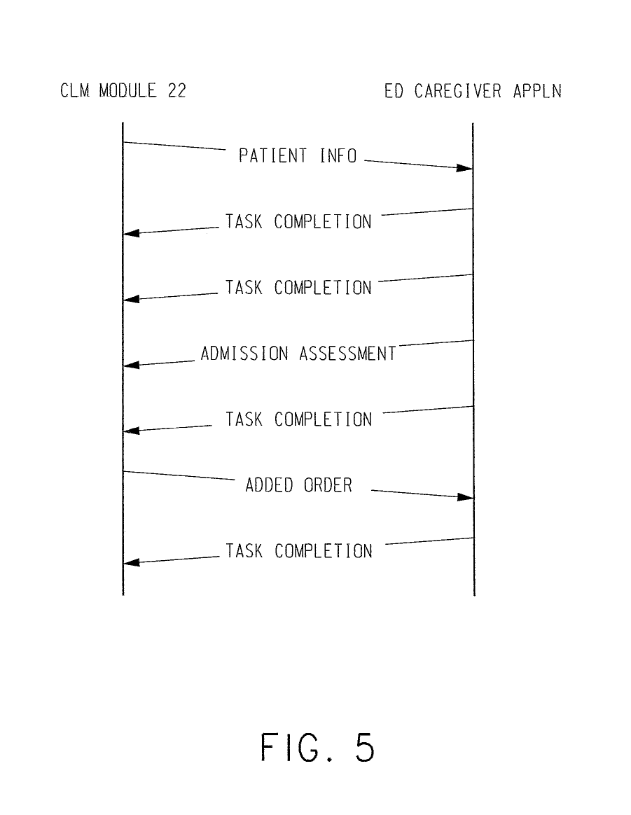

FIG. 5 shows an exemplary, non-limiting, interaction between CLM module 22 and the ED caregiver application running on the handheld device 2 of a caregiver in the ED. Task completion information communicated to CLM module 22 from handheld devices 2 in the ED unit is a rich source of data. The task completion information received by CLM module 22 from the handheld device 2 of a caregiver in the ED unit can be exported from CLM module 22 to, for example, without limitation, hospital IT system 16, for detailed statistical analysis, e.g., to compute the average completion time for each task. Analysis of task completion information can be beneficial for general process efficiency reviews, as well as measurement of performance of individual caregivers. The task completion information can also be used for billing purposes to document, with great detail, the tasks completed for a given patient. To this end, each task can have an associated billing code/amount. At a suitable time, a bill (invoice) can be prepared from the task completion information for a patient, wherein said bill can include an invoice total and can further include for each task a brief description and/or task code for each task along with invoice amount for said task.

Bed Board Interface Module

In order to match up bed requests with bed availabilities, many hospitals use a so-called bed board system which displays all beds in the hospital. The bed board system is typically manually operated by at least one facility person (e.g., an admissions nurse) who monitors bed availability and manually assigns new patients to available beds.

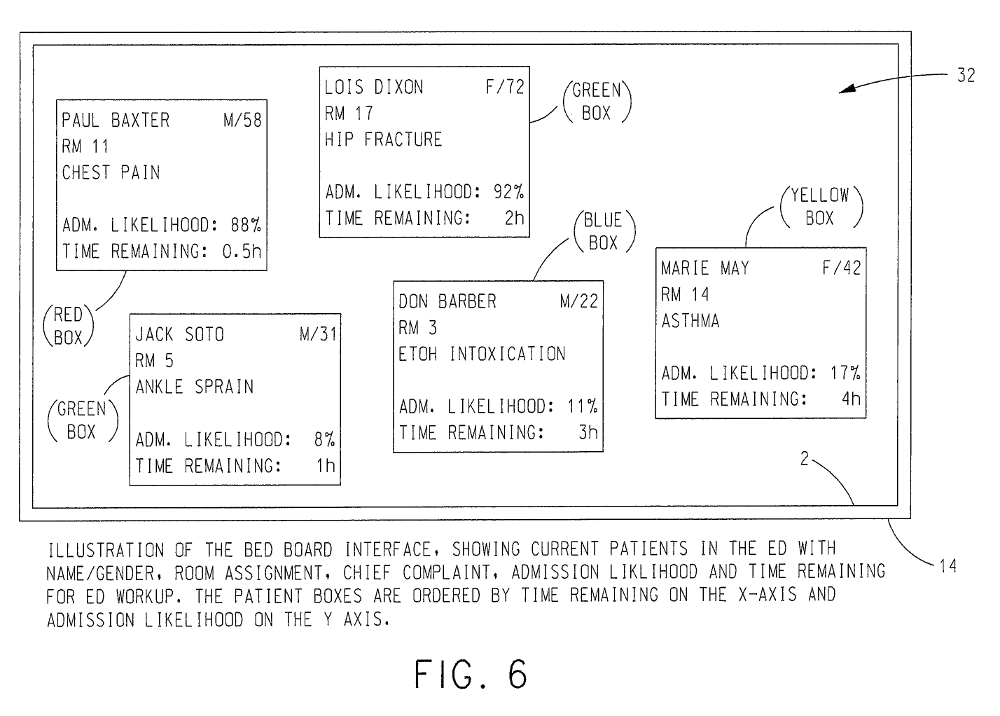

With reference to FIG. 6, in accordance with the present invention, a graphical interface 32 can be displayed on the visual display 14 of the handheld device 2 of each facility personal charged with assigning new patients to available beds under the control of bed board interface module 28 of server computer 2. Graphical interface 32 can display (in one or multiple screens) one or more of the following for each patient in the ED unit: the patient's estimated likelihood of admission to an interior unit, the patient's intended time of admission to an interior unit, and the patient's likely interior unit. In one exemplary, non-limiting embodiment shown in FIG. 6, graphical interface 32 indicates time remaining until the end of the ED workup on the x-axis, likelihood of admission to an interior unit on the y-axis, and the likely admitting interior unit through the color of the box representing each patient. The facility personal of each handheld device 2 on which graphical interface 32 is displayed can select a box representing a given patient to view more detailed data. Graphical interface 32 can be updated, desirably in real-time, by CLM module 22 with data from prediction module 24 as discussed above.

Bed Plan Module

Also or alternatively to bed assignment of an ED patient via the bed board system or bed board interface described above is the use of bed plan module 30 running on CLM server 4. Bed plan module 30 obtains bed occupancy information from the EMR application hosted by hospital IT system 16 and dispatches a suggested bed assignment for the ED patient to the handheld device 2 of one or more unit personnel (e.g., a unit nurse) in an interior unit via CLM module 22. Each handheld device 2 receiving a suggested bed assignment can display the suggested bed assignment in a suitable graphical interface. The unit personnel of each handheld device 2 displaying a suggested bed assignment can respond to the suggested bed assignment (by either accepting or rejecting the suggested bed assignment) by selecting a suitable real or virtual button of the handheld device 2

If the suggested bed assignment is accepted, the bed is then marked as occupied in the hospital's EMR application. If no beds are available, bed plan module 30 can provide to the handheld devices 2 of one or more unit personnel suggest discharges based on information from the hospital's EMR application. Once a discharge suggestion has been accepted, CLM module 22 informs personnel in the patient's virtual team of the need to collaborate in the discharge process.

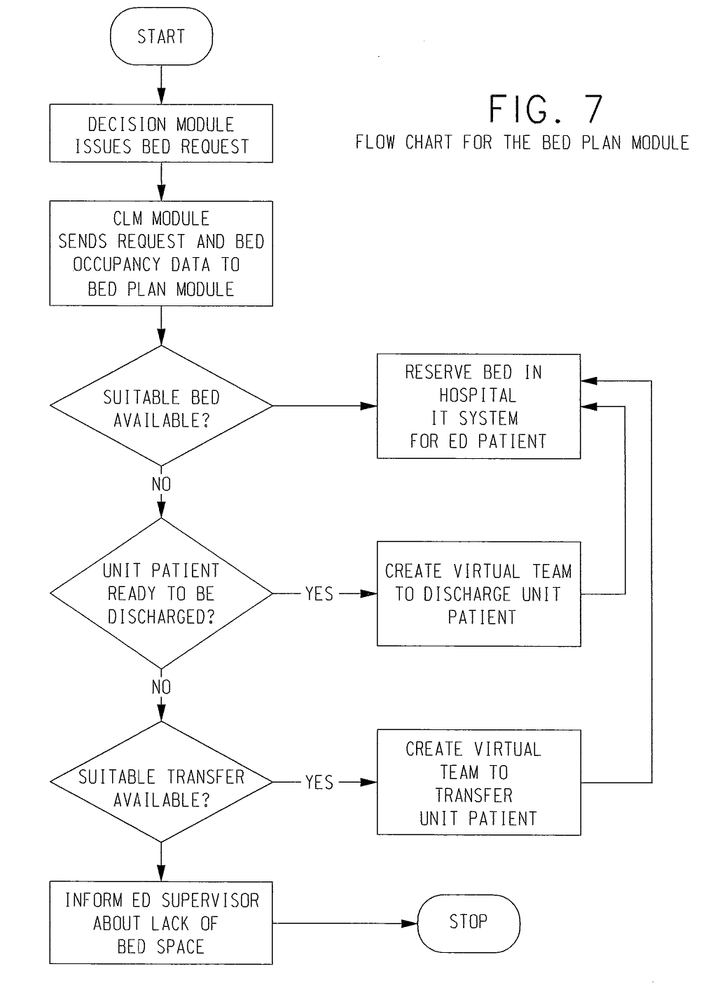

If a bed is not available in a desired interior unit, bed plan module 30 can search for an alternative bed (in another unit) using a previously determined mapping of possible transfers (e.g. from ICU to a surgical unit, or from the operating room (OR) unit to a trauma unit). If a bed is found, personnel in the discharging and receiving units are put by CLM module 22 into a virtual team to facilitate the patient transfer. FIG. 7 is a flow chart of the exemplary steps implemented by bed plan module 30.

Unit Caregiver Application

Caregivers (e.g., nurses) in interior units of a facility (e.g., units other than the ED unit) can be assigned handheld devices 2, each of which runs a unit caregiver application that resides on the computer storage 10 of said handheld device 2 and which enables said handheld device 2 to receive from CLM module 22 alerts for new bed requests (in case bed space is available) as well as discharge and transfer requests. Interior unit caregivers can confirm or deny requests using real or virtual buttons on their handheld devices 2. In case a request is denied the personnel (e.g., supervisory nurses) of the two participating units are put in a virtual team to resolve the denial.

Patient Guidance Module

With continuing reference to FIGS. 1 and 3, in another embodiment of the present invention, CLM server 4 can further include a patient guidance module 34 that can be operative to download a custom guidance application to handheld devices 2 of patients via transceiver 8. In this embodiment, it is envisioned that handheld devices 2 utilized by patients can be so-called smart phones, such as the Apple® iPhone®, that can utilize any suitable and/or desirable form(s) of wireless network(s), e.g., a cellular telephone network, to communicate with CLM server 4 via wireless transceiver 8. However, this is not to be construed as limiting the invention. Apple® and iPhone® are registered trademarks of Apple Inc. Corporation California, 1 Infinite Loop, Cupertino, Calif. 95014.

Herein, it is envisioned that wireless transceiver 8 can operate under the control of CLM server 4, can be a gateway to a third party wireless network, e.g., a cellular telephone network (not shown), that manages communication between CLM server 4 and handheld devices 2, or can be some combination thereof that facilitates communication between CLM server 4 and handheld devices 2. Accordingly, the illustration in FIG. 3 of wireless transceiver 8 as being part CLM server 4 is not to be construed as limiting the invention.

During the initial setup of the custom guidance application resident in a patient's handheld device 2, the patient can include, among other things, data regarding his demographic information, medical history, and insurance information. This data can be stored under the control of the custom guidance application, desirably in encrypted form, on the handheld device 2 and/or remotely, e.g., on a server of a wireless cellular carrier.

When medical care is needed, the patient (or a person acting on behalf of the patient) can initialize the custom guidance application and enter into the custom guidance application basic triage information (e.g. chief complaint, duration of symptoms, etc.). Once entry of the basic triage information is complete, this basic triage information along with the patient's medical history and the current location (determined via a GPS receiver 36 (shown in FIG. 1) of the patient's handheld device 2) can be transmitted, desirably in encrypted form, to CLM server 4.

An optional, expanded version of the custom guidance application can also be available to handheld devices 2 utilized by EMTs in ambulances. In addition to basic triage information, the expanded version of the custom guidance application can operative for receiving enhanced triage information, such as current vital signs, and for transmitting the basic and enhanced triage information to CLM server 4.

In response to receiving basic and, optionally, enhanced triage information, the patient's medical history and the patient's current location, and, optionally, real-time information of the current patient census from one or more participating medical facilities (e.g., EDs, urgent care centers and the like), patient guidance module 24:
converts chief complaint and other triage information to a resource need profile using a predetermined mapping table;
matches the need profile with the capabilities of medical facilities in the vicinity of the patient (as determined from the current location of the patient determined via GPS receiver 36) to identify medical facilities that are capable of treating the patient;
sorts the medical facilities by distance to the patient; and
depending on the triage data, optionally factors in patient census (if available) into the rank order (e.g., a more distant facility with a lower patient census would be ranked higher than a closer facility with a high census).

CLM server 4 then returns to the handheld device 2 that initiated the inquiry an ordered list of two or more suggestions of facilities that the patient can go to. The suggestion for each facility can optionally take into account one or more of the following: available resource(s) at the facility; the distance and/or travel time from the patient to the facility (based on the GPS data), the current patient census (if available), estimated wait time, cost of patient care at the facility, and the like. The patient (or EMT) can then select on his handheld device 2 one of the facilities and state their mode of transportation (e.g. car, ambulance, bus). This selection and mode of transportation can then be transmitted, along with the patient's triage data, to CLM server 4 for forwarding to hospital IT system 16 of the selected facility as an advance notice that the patient is in transit to the facility. The patient's triage data can then be entered by CLM module 22 into prediction module 24 in the manner discussed above to determine, among other things, the likelihood of admission, time until the conclusion of ED workup, and, assuming the patient is likely to be admitted, the facility unit where the patient will be admitted following ED workup.

The method and system described above uses data collected in the course of a patient's stay in the ED, e.g., triage data, vitals, and physician orders/tasks, to predict future demand for a resource, namely, a bed space. There is, however, nothing fundamentally unique, from a resource prediction point of view, about a bed resource versus any other resource (capital resource or human resource) in the facility such as, without limitation, a specialist consult, a medical diagnostic imaging scan (X-ray, CT, MRI, ultra-sound, etc.), a lab test, etc. Hence, it is envisioned that the methods and system described above can be applied to any hospital resource potentially required by a patient in the ED. To this end, prediction module 24 can be the same as discussed above, with simply the classification targets used during training of the system being changed. In this regard, bed plan module 30 and bed board interface module 28 can be replaced with one or more other modules suitable for allocating these other resource in the facility.

The invention has been described with reference to the preferred embodiment. Obvious modifications and alterations will occur to others upon reading and understanding the preceding detailed description It is intended that the invention be construed as including all such modifications and alterations insofar as they come within the scope of the appended claims or the equivalents thereof.

The invention claimed is:

1. A method of patient flow and treatment management via one or more computerized user devices in operative communication with a programmed computer, the method comprising:
(a) receiving in the computer patient information regarding a patient admitted to a first unit of a patient treatment facility, said patient information comprising one or more of the following: patient triage data, patient vital signs, one or more tasks related to treatment of the patient, and a completion state of each said task;
(b) a prediction module hosted by the computer predicting the following based on said patient information received in step (a):
(1) a future demand of the patient requiring a resource in either the first unit or a second unit of the facility, and
(2) a length of time before the resource in step (b)(1) is required;
(c) the computer dispatching to one or more of the user devices a request for the resource, said request determined by a decision module hosted by the computer based on the prediction in step (b); and
(d) the computer receiving from at least one of the user devices dispatched the
request for the resource in step (c) a confirmation or denial of the request for the resource, wherein:
a machine learning algorithm is used for the prediction in step (b)(1); and
a nonlinear regression algorithm is used for the prediction in step (b)(2).

2. The method of claim 1, further including repeating steps (a)-(d) for another patient admitted to the first unit.

3. The method of claim 1, further including maintaining a record of the state of each task as being either complete or not complete.

4. The method of claim 1, wherein at least part of the patient information received by the computer in step (a) is initially input into one or more of the user devices.

5. The method of claim 1, wherein the resource includes one of the following: a capital resource or a human resource.

6. The method of claim 5, wherein:
the human resource includes a specialist; and
the capital resource includes a bed, a medical diagnostic imaging scan, or a lab test.

7. A method of patient flow and treatment management via one or more computerized user devices in operative communication with a programmed computer, the method comprising:
(a) receiving into a first user device patient information regarding a patient admitted to a first unit of a patient treatment facility, said patient information comprising one or more of the following: patient triage data, patient vital signs, one or more tasks related to treatment of the patient, and a completion state of each said task;
(b) dispatching the patient information received in step (a) from the first user device to the computer;
(c) receiving at a second user device from the computer a request for a resource in either the first unit or a second unit of the facility, wherein the request for the resource is determined based on a prediction of the following determined based on the patient information dispatched to the computer in step (b):
(1) a future demand of the patient requiring the resource, and
(2) a length of time before the resource in step (c)(1) is needed; and
(d) the second user device dispatching to the computer a confirmation or denial of the resource request of step (c), wherein:
a machine learning algorithm is used for the prediction in step (c)(1); and
a nonlinear regression algorithm is used for the prediction in step (c)(2).

8. The method of claim 7, further including repeating steps (a)-(d) for another patient admitted to the first unit.

9. The method of claim 7, further including maintaining a record of the state of each task as being either complete or not complete.

10. The method of claim 7, wherein the resource includes one of the following: a capital resource or a human resource.

11. The method of claim 10, wherein:
the human resource includes a specialist; and
the capital resource includes a bed, a medical diagnostic imaging scan, or a lab test.

12. A method of patient flow and treatment management via one or more computerized user devices in operative communication with a programmed computer, the method comprising:
(a) receiving into a first user device patient information regarding a patient admitted to a first unit of a patient treatment facility, said patient information comprising one or more of the following: patient triage data, patient vital signs, one or more tasks related to treatment of the patient, and a completion state of each said task;
(b) dispatching the patient information received in step (a) from the first user device to the computer;
(c) receiving at the computer the patient information dispatched in step (b);
(d) the computer running a prediction application that predicts an estimate of the following based on the patient information received in step (c):
(1) a future demand of the patient requiring a resource in either the first unit or a second unit of the facility, and
(2) a length of time before the resource of step (d)(1) is needed;
(e) the computer running a decision module that determines based on the estimates predicted in step (d) that a request for the resource should be issued;
(f) the computer dispatching the resource request to one or more of the user devices;
(g) each user device dispatched the resource request in step (f) displaying said resource request on a display of said user device; and
(h) the computer receiving from at least one of the user devices dispatched the resource request in step (f) a confirmation or denial of the resource request, wherein:
a machine learning algorithm is used for the prediction in step (d)(1); and
a nonlinear regression algorithm is used for the prediction in step (d)(2).

13. The method of claim 13, wherein:
the first user device is assigned to a person in the first unit; and
the one or more user devices of step (f) includes a second user device assigned to a person in the second unit.

14. The method of claim 14, wherein step (h) includes the second user device dispatching to the computer the confirmation or denial of the resource request.

15. The method of claim 13, wherein the resource includes one of the following: a capital resource or a human resource.

16. The method of claim 1, wherein the patient triage data includes one or more of the following: age of the patient; gender of the patient; mode of the patient's arrival at the facility; time of the patient's arrival at the facility; recent patient treatment facility visits by the patient, the patient's symptom(s) regarding the patient being admitted to the first unit, the patient's decision to seek medical treatment, and a duration of the symptom(s).

17. The method of claim 7, wherein the patient triage data includes one or more of the following: age of the patient; gender of the patient; mode of the patient's arrival at the facility; time of the patient's arrival at the facility; recent patient treatment facility visits by the patient, the patient's symptom(s) regarding the patient being admitted to the first unit, the patient's decision to seek medical treatment, and a duration of the symptom(s).

18. The method of claim 12, wherein the patient triage data includes one or more of the following: age of the patient; gender of the patient; mode of the patient's arrival at the facility; time of the patient's arrival at the facility; recent patient treatment facility visits by the patient, the patient's symptom(s) regarding the patient being admitted to the first unit, the patient's decision to seek medical treatment, and a duration of the symptom(s).

19. The method of claim 1, wherein, in step (b), the prediction module further predicts an identity of the first or second unit.

20. The method of claim 7, wherein the prediction in step (c) further includes an identity of the first or second unit.
